(19) United States
(12) Patent Application Publication
(10) Pub. No.: US 2004/0025018 A1
(43) Pub. Date: Feb. 5, 2004

(54) Secure end-to-end communication in mobile ad hoc networks

(76) Inventors: Zygmunt J. Haas, Summit, NJ (US); Panagiotis Papadimitratos, Ithaca, NY (US)

Correspondence Address: William A. Blake, Jones, Tullar & Cooper, P.C., P.O. Box 2266 Eads Station, Arlington, VA, 22202, US

(21) Appl. No.: 10/349,181

(22) Filed: Jan. 23, 2003

Related U.S. Application Data
(60) Provisional application No. 60/350,013, filed on Jan. 23, 2002.

(51) Int. Cl. H04L 9/00

(52) U.S. Cl. 713/168

(57) ABSTRACT

A secure routing protocol for an ad hoc network requires only that the communicating end nodes have a security association. The protocol combines a secure route discovery protocol and a secure message transmission (SMT) protocol to provide comprehensive security. The secure routing protocol provides connectivity information through the discovery of one or more routes in the presence of adversaries that actively disrupt the routing operation. A route discovery request is sent from a source node to a destination node, which responds by sending a reply over the same route taken by the request. The source and destination nodes use a shared secret key to verify the authenticity of the request, reply and determined route. Using a discovered plurality of routes, The SMT protocol separates messages to be transmitted into multiple segments and routes the segments across the set of routes simultaneously. The destination node sends feedback to the source which identities which segments were received. The source uses this information to resend segments that were not received and identify failed routes. If not sufficiently many or no routes at all are available, a new route discovery is initiated.

### CROSS-REFERENCE TO RELATED APPLICATIONS

This application claims priority, under 35 U.S.C.§ 119(e), on U.S. Provisional Application No. 60/350,013, filed Jan. 23, 2002.

### STATEMENT REGARDING FEDERALLY SPONSORED RESEARCH

This invention was made with Government support from the National Science Foundation (NSF) under Grant No. ANI-9980521, and the Office of Naval Research (ONR) under Grant No. N00014-00-1-0564. The Government has certain rights in the invention.

### BACKGROUND OF THE INVENTION

1. Field of the Invention

The present invention relates in general to a system and method for providing secure communications in mobile ad hoc networks.

2. Description of the Background Art

The vision of nomadic computing and ubiquitous wireless network access has stimulated much interest in the emerging Mobile Ad Hoc Networking (MANET) technology. Infrastructure-less, self-organizing wireless networks are expected to operate autonomously, or as an extension to the wired networking infrastructure. The MANET paradigm seeks to enable communication across networks whose topology and membership may change very frequently, based on the cooperative support of the network functionality. However, the peer-to-peer node interaction opens MANET protocols to abuse. Malicious nodes can disrupt or even deny the communications of potentially any node within their ad hoc networking domain. This is so, exactly because each and every node is not only entitled, but is, in fact, required to assist the network operation.

With migrating nodes joining and leaving MANET domains and transient associations between nodes constantly established and torn down, it is particularly difficult to distinguish which nodes are trustworthy and supportive. First, the practically invisible or non-existent administrative boundaries encumber the a priori classification of a subset of nodes as trusted. Second, it is impractical, in such a volatile communication environment, to determine which nodes can be trusted based on the network interaction—the overhead and especially the delay to make such an inference would be prohibitive, with additional overhead and complexity imposed if such inferences were to propagate in the form of recommendations or accusations.

In most cases, transiently associated nodes will assist each other with the provision of mere basic networking services, such as route discovery and data forwarding. As a result, the nodes, or, practically the users of the devices, may have no means to establish a trust relationship. This is so, because of the absence of prior context, since mobile nodes will not necessarily pursue collectively a common mission.

In other words, in mobile ad hoc networks, the particular challenge is to safeguard the correct operation of the network layer protocols. Nodes may be designated as trusted or non-trusted at the application layer—for example, access to a service or participation to its collaborative support would be allowed only to nodes that present the necessary credentials. However, only closed, mission-oriented networks could satisfy such an assumption of full trust. Thus, the reliance on trusted nodes solely would drastically narrow the scope and limit the potential of ad hoc networking.

A number of secure routing protocols for MANET have appeared in the literature. They fall mainly into two categories: solutions that target to secure the route discovery, or solutions to mitigate malicious or selfish behavior regarding the forwarding of data.

In the former category, it has been proposed to tackle the protection of the route discovery process as an additional Quality-of-Service (QoS) issue, by choosing routes that satisfy certain quantifiable security criteria. Nodes are classified into different trust and privilege levels. A node initiating a route discovery sets the sought ‘security’ for the route, that is, the required minimum trust level for nodes participating in the query/reply propagation. At each trust level, nodes share symmetric encryption and decryption keys. Intermediate nodes of different levels that cannot determine whether the required QoS parameter can be satisfied or decrypt in-transit routing packets drop them. This scheme provides protection (e.g., integrity) of the routing protocol traffic against adversaries outside a specific trust level.

An extension of the Ad Hoc On-demand Distance Vector (AODV) routing protocol has been proposed in order to protect the routing protocol messages. The Secure-AODV scheme assumes that each node has the certified public keys of all network nodes, since intermediate nodes validate all in-transit routing packets. The basic idea is that the originator of a control message appends an RSA signature and the last element of a hash chain, i.e., the result of n consecutive hash calculations of a random number. As the message traverses the network, intermediate nodes crypto graphically validate the signature and the hash value, generate the k-th element of the hash chain, with k being the number of traversed hops, and place it in the packet. The route replies are provided either by the destination or by intermediate nodes that have an active route to the sought destination, with the latter mode of operation enabled by a different type of control packets.

A second proposal to secure AODV makes use of public key cryptography as well and operates in two stages, an end-to-end authentication, and an optional secure shortest path discovery. First, a signed route request propagates to the sought destination, which returns a signed response to the querying node. At each hop, for either direction, the receiving node validates the received control packet and forwards it after signing it. At the second stage, a ‘shortest path confirmation’ packet is sent towards the destination, while now intermediate nodes sign the message in an onion-like manner in order to disallow changes of the path length.

A scheme to secure a protocol known as the Dynamic Source Routing Protocol (DSR) utilizes a broadcast authentication scheme, initially proposed to protect multicast traffic flows, to authenticate control traffic. Basically, nodes periodically release keys that belong in pre-calculated hash chains in order to authenticate messages, i.e., control packets, on which they previously appended a message authentication code (MAC) calculated with the revealed key. To support such functionality, nodes have synchronized clocks and must be initially bootstrapped with the commitment to a hash chain from all other network nodes. In addition, shared keys must be available for each pair of communicating nodes. As a route query propagates, intermediate nodes place their address in the packet, along with a MAC covering the packet, and the destination validates the request from the end-to-end shared key MAC. When the reply is relayed back towards the source, the same intermediate nodes reveal, i.e., append their key to the reply so that the corresponding hops can be authenticated.

As for security solutions targeting MANET data forwarding, it has been proposed to detect misbehaving nodes and report such events to the rest of the network, so that all nodes maintain a set of metrics reflecting the past behavior of other nodes, and then select routes of relatively well-behaved nodes. However, no provisions are made so that nodes receiving misbehavior reports are be able to validate their authenticity or correctness, with some more recent work simply assuming a fully trusted network, with all nodes having full knowledge of the all other nodes' credentials (public keys). A different approach provides incentive to nodes, so that they comply with protocol rules and properly relay user data. The assumed greedy nodes forward packets in exchange for fictitious currency. The scheme operates under the assumption of an overlaid geographic routing infrastructure, a Public Key Infrastructure (PKI), the use of physically tamper-resistant modules that handle the currency-related operations, and the ability of the nodes to undertake frequent (at a rate equal to the establishment of new links with neighboring nodes) public-key cryptographic computations.

The foregoing schemes suffer from a number of drawbacks. First, they require that all network nodes be bootstrapped with or acquire valid credentials (shared, public keys, and hash chain commitments) for all other nodes. In addition, the known schemes make use of public key cryptography for validating control traffic and have special requirements on the node equipment (e.g., GPS or synchronized clocks). These restrictions can be impossible to satisfy for MANET domains of changing membership comprised mainly of disparate network nodes that lack prior associations, bear heterogeneous equipment, operate in varied physical environments where node equipment such as GPS does not function, or have limited processing capabilities that render cryptographic validation of each in-transit packet prohibitively expensive. In view of the foregoing, a need exists for a scheme for insuring the security of communications in ad hoc networks that does not impose such restrictions on, nor require verification of the trustworthiness of, each and every node in the network.

### SUMMARY OF THE INVENTION

The present invention addresses the foregoing need through provision of a security method and system for ad hoc network routing protocols that require, both in the discovery of routes and the forwarding of data, only that the communicating end nodes have a security association. More particularly, the invention combines two components, a secure route discovery protocol and a secure data forwarding or message transmission protocol, to provide comprehensive security for the routing protocol. Each of the components can be viewed independently and be combined with or extend the functionality of other MANET routing protocols. For example, the secure data forwarding or message transmission protocol can secure and enhance the fault tolerance of data forwarding on top of any other protocol, or secure routing protocol in particular. Similarly, the secure route discovery protocol can complement any scheme that mitigates malicious packet dropping. The effectiveness, efficiency and scope of each such possible combination will be dependent on the features and assumptions of the accompanying protocol.

The secure routing protocol provides connectivity information through the discovery of one or more routes in the presence of adversaries that actively disrupt the routing operation. The secure message transmission (SMT) protocol utilizes this routing information, determines a number of distinct paths between the source and destination nodes, introduces transmission redundancy and cryptographic protection, and routes data across the set of paths simultaneously. As feedback is received from the destination, paths are deemed as failed by the source. If not sufficiently many or no paths at all are available, a new route discovery is initiated. The interaction between the data forwarding and the route discovery can be bi-directional. The richer the connectivity information provided by the route discovery, the more flexible and effective the selection of paths for data forwarding. Inversely, the stronger the assurances of the data forwarding, the higher the number of routes the discovery will be requested to provide.

To safeguard the route discovery, that is, to provide factual, up-to-date and authentic connectivity information, the present invention requires that only the end communicating nodes are securely associated, e.g., using a shared secret key, with no need for cryptographic operations on control traffic at intermediate nodes, two factors that render the scheme efficient and scalable. The processing overhead is placed primarily on the end nodes, an appropriate choice for a highly decentralized environment, and contributes to the robustness and flexibility of the scheme.

In the preferred embodiments, the source node S initiates the route discovery, by constructing a route request packet identified by a pair of identifiers: a query sequence number and a random query identifier. The source and destination end nodes and the unique (with respect to the pair of end nodes) query identifiers are the inputs for the calculation of the Message Authentication Code (MAC), along with a shared secret key, K (S,T). Route requests are (re-) broadcasted, while the identities (IP addresses) of the traversed intermediate nodes are accumulated in the route request packet. As an alternative implementation, intermediate nodes do not append their identity in the request packet; instead, they maintain temporary information to identify the request and the node from which they received it, in order to later relay the corresponding reply towards the querying node S.

Nodes maintain a limited amount of information identifying relayed request packets, so that packets that correspond to recent previously seen requests can be discarded. In addition, nodes maintain information regarding the data link and network addresses of their immediate neighbors, and perform a number of simple non-cryptographic checks on the relayed control traffic, based solely on the packet content, and discard non-compliant packets. Intermediate nodes also regulate the service rate they provide to control traffic originating or being forwarded by each neighbor. Finally, they may provide the source of a route with a notification in the event of a path breakage, and may provide route replies.

The destination node T validates incoming request packets, and constructs route replies to not previously received queries originating from the source node S. T calculates a MAC covering the route reply contents and returns the packet to S over the reverse of the route that the request packet traversed. This can be achieved both when the discovered route is accumulated in the corresponding request packet and when relaying nodes record their predecessor: in the former case, source routing is used, while in the latter case each node relays the replay to its recorded predecessor. The destination node may respond to more than one request packets of the same query, so that it provides the source node with an as diverse topology picture as possible.

The basic idea behind the secure data forwarding protocol is to combine efficient end-to-end security services and a robust feedback mechanism, with dispersion of both data and feedback packets, and simultaneous usage of multiple paths. At the same time, continuous reconfiguration driven by an easy-to implement method allows the adaptation of the secure data forwarding to the requirements of the networking environment. For each outgoing message limited redundancy is introduced and the data with the redundant information are divided to a number of pieces. More particularly, each message is divided into a number of pieces and each of the pieces, equipped with a cryptographic header, is transmitted over a different route to the destination node. Due to the message dispersion, the reception of a fraction of the message's pieces can allow successful reconstruction at the receiver's side. A cryptographic header is appended to each piece and the dispersed message is transmitted over a set of diverse, preferably node-disjoint paths. Diversity is welcome, so that a malicious node cannot harm more than one piece.

The receiver validates the incoming packets and acknowledges the successfully received packets, with the feedback cryptographically protected as well. If a sufficient number of pieces were received, the receiver reconstructs the message. Otherwise, it awaits the additional needed packets to be retransmitted by the sender. Once the message is successfully reconstructed, it is passed to the upper layer protocol.

The foregoing approach addresses the most characteristic vulnerability of ad hoc networking, the operation of the routing protocol. Securing the routing protocol is a pre-requisite for trustworthy communications in an open, peer-to-peer, collaborative, self-organizing networking environment. By closely interweaving the security mechanisms with the network-layer operation, the flexibility to cope with a frequently changing network is retained. The end-to-end operation reflects on the cryptography-based security mechanisms and provides a twofold gain. It renders the communication scheme generally applicable, even for nodes of limited computational capabilities; it allows it to scale to networks of increasing sizes, since nodes need to have or establish a secure association with a small subset of the network, their sought destinations, over different periods of time. Additionally, the overhead stemming from the security measures is imposed mostly, if not entirely, on nodes that communicate in a secure manner and that directly benefit from the provided security.

The secure route discovery protocol provides correct end-to-end connectivity information as well as very strong assurances on the correctness of the link-level connectivity information. One or more route replies are provided with correctness verified by the route “geometry” itself. Meanwhile, compromised and invalid routing information is discarded either by intermediate nodes without the use of cryptographic validation, or ultimately by the querying node itself. The route request packets verifiably propagate to the destination and route replies are returned strictly over the reverse of the route followed by the corresponding route request packet.

By securing the route discovery, the adversarial nodes are deprived of an effective means to systematically disrupt the communications of their peers. Attackers cannot impersonate the sought destination and attract data traffic, they cannot respond with stale or corrupted routing information, they are stopped from broadcasting forged control packets to obstruct the propagation of legitimate queries, and they are unable to distort or even dictate the topology knowledge of benign nodes.

However, neither the secure route discovery technique of the subject invention nor any other secured routing protocol guarantee that the nodes along the correctly discovered routes will indeed relay the data as expected. An adversary may misbehave in an intermittent manner, that is, provide correct routing information during the route discovery stage, and later forge, corrupt, or drop data packets during the data forwarding stage. Upper layer mechanisms, such as reliable transport protocols, cannot cope with malicious disruptions, and the communicating nodes may be easily deceived for long periods of time that the data flow is undisrupted. Although the cryptographic protection of the exchanged traffic can mitigate a number of attacks, it does not shield the communication against Denial of Service (DoS) attacks. Routes that are not free of malicious nodes may be repeatedly chosen, and to communicate nodes may have to rely on long cycles of disconnection detection and new route discovery.

The secure data forwarding protocol counters such intermittent malicious behavior and supports real-time communication, after the discovery of routes between the source and the destination has been already performed. Such attacks are countered without network monitoring and misbehavior detection. As a result, the complexity and long periods of observation needed to determine ‘safe’ paths are avoided. Furthermore, the effective protection of transmissions does not depend on the attack pattern, for example, and the selection of the packets to drop or corrupt. The scheme is capable of supporting real-time traffic, while adapting to the network conditions to provide either enhanced security and resilience, or highly efficient operation in a relatively safer environment. It is important that the protocol can be a self-contained solution tailored to MANET characteristics. It does not rely on assumptions on lower or higher layer protocols, and thus, it does not impose additional complexity due to cross-layer interactions.

### BRIEF DESCRIPTION OF THE DRAWINGS

The features and advantages of the present invention will become apparent from the following detailed description of a number of preferred embodiments thereof, taken in conjunction with the accompanying drawings, in which:

FIG. 1 is a block diagram of an example of a multiple node ad hoc network that can be configured to operate in accordance with the principles of the present invention;

FIG. 2 is a block diagram of a communications node of the type employed in the ad hoc network of FIG. 1;

FIG. 3 is a graphical representation of an example of a secure message transmission using the secure message transmission (SMT) protocol of the present invention;

FIG. 4 is an illustration of an SMT protocol header, which is attached to each IP packet carrying a message piece to secure its transmission; and

FIG. 5 is an illustration of an SMT acknowledgment, showing the header and payload.

### DETAILED DESCRIPTION OF THE PREFERRED EMBODIMENTS

1. Exemplary Network

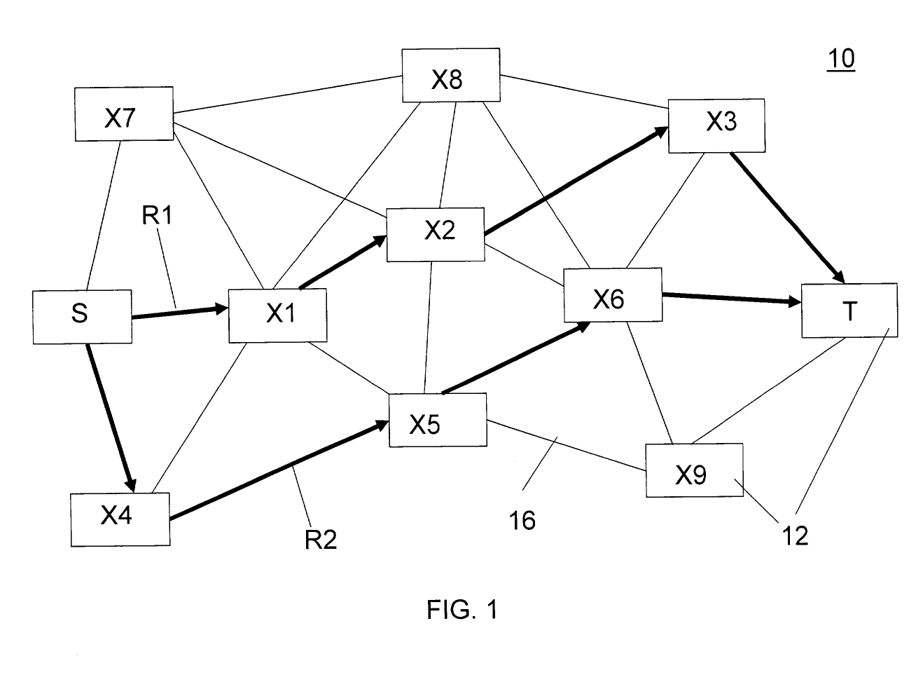

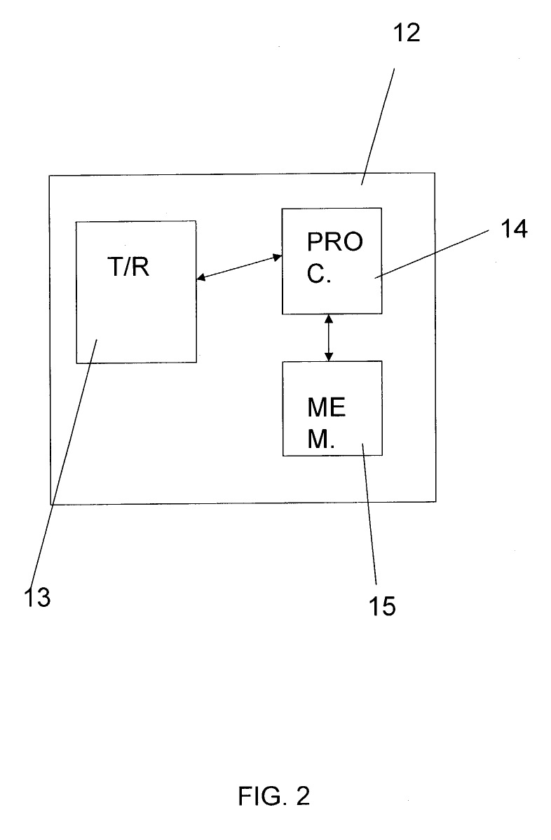

With reference to FIG. 1, an ad hoc network 10 is illustrated that can be configured to operate in accordance with the principles of the present invention. The network 10 includes a plurality of communications nodes 12, many or all of which can be portable and mobile. As an example, the nodes 12 can be associated with military vehicles or personnel in the field. As is conventional and as illustrated in FIG. 2, each node 12 includes a transceiver 13 for transmitting and receiving communications to and from the other nodes 12 in the network 10. In addition, each node 12 includes a processor 14 for processing information requests from other nodes, managing node routing and location information, performing route discovery, calculating routing trees and paths, and encrypting data in accordance with the preferred embodiments of the present invention. A memory 15 is also interfaced to the processor 14 for storing a database of node location and route information for all other nodes in the network 10, as well as for storing routing tree and path sets. Each of the nodes 12 communicates with other of the nodes 12 over a plurality of wireless transmission links 16. In an ad hoc network, when a source one of the nodes 12 denoted S wants to transmit a message to a destination one of the nodes 12 denoted T, the source node S must determine a route by which the message will be transmitted. The route is comprised of a sequence of the links 16 in combination with one or more intermediate ones of the nodes 12, which relay the message along the desired route. In FIG. 1, these intermediate nodes are labeled X1, X2, X3, . . . , X8, X9. In addition, two examples of diverse routes are labeled R1 and R2, where R1 is defined by the node sequence S, X1, X2, X3, T and R2 is defined by the node sequence S, X4, X5, X6, T. The sequences of the links 16 that make up R1 and R2 are illustrated with thicker, arrowed lines in FIG. 1. The heart of the present invention lies in the secure manner by which routes are first discovered and then messages or other data are sent over the determined routes.

2. Design and Security Goals

At the outset, the ultimate goal of the present invention is to deliver data successfully to the sought destination, across an unknown multi-hop wireless network. The invention seeks to secure communication in an open ad hoc network, where nodes can freely participate without prior authorization. No assumptions are made on the behavior or the motivation of the participating entities, that is, the nodes that collectively make up for the absent fixed routing infrastructure. Nodes can either comply with the employed protocol stack, or deviate in an arbitrary manner and exhibit malicious behavior. The sole requirement for two end nodes that wish to communicate in a secure manner is the ability to establish (or the prior existence of) a security association.

The primary goal is to ensure the availability of communication. The discovery of actual routes, that is, routes that correspond to existing and current connectivity and terminate at the sought destination is of paramount importance. To achieve this, the protocol has to provide authentic and correct routing information in a timely manner. Routing information is authentic when it is provided by the sought destination. It is correct when it corresponds to a factual route across the MANET topology: it corresponds to an existing sequence of nodes over and by which the route discovery control traffic was relayed, as a response to a query, with the reply not replayed from a past discovery. Accordingly, timeliness implies that the provided information is not obsolete, and that the protocol retains its responsiveness. Finally, the invention seeks to safeguard the survivability of the network against attacks that either attempt to obstruct the propagation of control traffic, or overwhelm the network with spurious transmissions.

With one or more routes at hand, which satisfy the above-stated properties, the goal of the scheme is to counter attacks against the forwarding of data as well. The origin of the data must be authenticated, data must not be altered while in-transit, and adversaries must not be able to inject or replay data that are accepted by the source. Moreover, the transmission and thus reception of data must be unambiguously related with the utilized route: in other words, it is required to have a one-to-one correspondence between a successful transmission and a successful or operational path.

Additionally, the goal is to promptly detect the state of utilized paths, or in other words, evaluate the quality of the routes in terms of their ability to relay data to the destination. To avoid compromised routes, that is, routes on which adversarial nodes placed themselves, transmission failures must deem the path unusable. At the same time, the invention seeks to provide low communication delays: this requires low delays in detecting and avoiding compromised paths, along with the ability to mask such failures and still successfully deliver the data.

In the special case that nodes bear credentials to prove their identity, the goal of authorization can be added. Every node that has or can establish a secure association (SA) with it immediate neighbors must do so, utilizing its relevant credentials. As a result, all transmissions can be authenticated by nodes within one hop, or more precisely, with such nodes that have an established SA. Accordingly, transmissions that do not emanate from associated neighbors may be deemed spurious and discarded. In particular, such cryptographic validation of control and data traffic can strengthen the effectiveness and security of the Neighbor Look up protocol, which will be described below. However, it should be emphasized that the possession of credentials does not imply the bearing nodes will be well behaved. Instead, the correctness and robustness of the operation is achieved due to the functionality of the protocol.

Non-repudiation, that is, the inability of the origin of a message to deny having sent the message, is not required, since the scheme of the subject invention does not seek to explicitly detect and isolate adversarial nodes. Nevertheless, the ability to detect failures is required, as explained above. Finally, confidentiality of routing information is not a requirement. The nodes' IP addresses are dynamically or individually assigned and routes have limited lifetimes. Nevertheless, if the protocol operates without the use of source routing, the topological knowledge related to the data flows that an eavesdropper can acquire becomes very limited. In either case, such information cannot be valuable to an adversary, while privacy and anonymity issues do not pertain and are not harmed by the network layer operation.

Finally, one cannot underrate the need for security of each individual network node, as part of the overall problem of securing a distributed system. Due to the pervasive nature of MANET, networked devices may not always be under the continuous control of their owner. As a result, the physical security of the node may lead to the requirement of tamper-resistant nodes for certain environments. However, security problems manifest themselves in a more emphatic manner in a networked environment, and especially in mobile ad hoc networks. This is why in the present invention, the focus is on the network-related security issues. More importantly, the correctness of the subject scheme does not depend on the security of the devices.

3. Assumptions

The focus is on communication between a pair of nodes and it is assumed that a Security Association (SA) exists or can be established between the source (S) and destination (T) nodes. Such an association could be instantiated, for example, by the knowledge of the public key of the other communicating end. The existence of a SA is justified, because the end hosts choose to employ a secure communication scheme and, consequently, should be able to authenticate each other. For the following discussion, the existence is assumed of a shared secret key K (S,T) for each pair of communicating end nodes. The SA is bi-directional in that K (S,T) can be used for control traffic flowing in both directions, with relevant state maintained for each direction and end nodes able to use static or non-volatile memory.

Each node is equipped with a public/private key pair, namely E_V and D_V, and with a single network interface per node within a MANET domain (to support operation with multiple interfaces, one key pair should be assigned to each interface). Key certification can be provided by a coalition of K nodes and the use of threshold cryptography, the use of local repositories of certificates provided by the network nodes, or a distributed instantiation of a CA. Two nodes, S and T in particular, can negotiate a shared secret key, e.g., via the Elliptic Curve Diffie-Hellman algorithm, and then verify, using E_S and E_T respectively, that the principal that participated in the exchange was indeed the trusted node.

Nodes are identified by their IP addresses, which may be assigned dynamically as they join MANET domains or selected randomly. Although the correctness of the subject protocol does not require E_V to be tied to the node's IP address, it could be beneficial to use IP addresses derived from public keys. Each node has a single network interface at the data link layer and a one-to-one mapping between Medium Access Control and IP addresses is expected; this does not imply though that the node addresses are assumed fixed, as explained above.

Nodes are also assumed to be equipped with a one-way or hash function H and a public key cryptosystem. It is emphasized that public key cryptography is used very sparsely, since it is limited to the establishment of the end-to-end security association, if a prior association is absent. Furthermore, the subject protocol does not require any security association with or between intermediate nodes, which are not expected to perform any cryptographic operations when handling data or control traffic originating from their peers.

The adversarial nodes may attempt to compromise the route discovery and data operation by exhibiting arbitrary, Byzantine behavior. They are able to corrupt, replay, fabricate and inject routing or data packets, and are capable of misrouting any packet in any possible manner. However, adversaries are also subject to the limitations of the communication environment, i.e., packet loss, path breakages, and have finite processing power.

Links are assumed to be bi-directional, a requirement fulfilled by most of the proposed MAC protocols, especially the ones that employ an RTS/CTS dialogue. The underlying data link layer (e.g., IEEE 802.11) may provide reliable link transmission, although this is not a requirement of the scheme of the present invention. Additionally, data link security services, such as the Wired Equivalent Protocol (WEP) function are not required either. Finally, thanks to the broadcast nature of the radio channel, each transmission is received by all neighbors, which are assumed to operate in promiscuous mode.

4. Overview

The communication scheme of the present invention conceptually comprises two components: the secure discovery of routes and the secure transmission of data. As already discussed, each of the components can be viewed independently and be combined with or extend the functionality of other MANET routing protocols. For example, the secure message transmission protocol can secure and enhance the fault tolerance of data forwarding on top of any other protocol, or secure routing protocol in particular. Similarly, the secure discovery of topology can complement any scheme that mitigates malicious packet dropping. The effectiveness, efficiency, and scope of each such possible combination will be dependent on the features and assumptions of the accompanying protocol.

The secure routing protocol is responsible for providing connectivity information through the discovery of one or more routes in the presence of adversaries that actively disrupt the routing operation. The secure data transmission protocol utilizes this routing information, determines a number of distinct paths, introduces transmission redundancy and cryptographic protection, and routes across the set of paths simultaneously. As feedback is received from the destination, paths are deemed as failed by the source. If not sufficiently many or no paths at all are available, a new route discovery is initiated. The interaction between the data forwarding and the route discovery can be bi-directional. The richer the connectivity information provided by the route discovery, the more flexible and effective the selection of paths for data forwarding. Inversely, the stronger the assurances of the data forwarding, the higher the number of routes the discovery will be requested to provide.

5. Secure Route Discovery

To safeguard the route discovery, that is, to provide factual, up-to-date and authentic connectivity information, the present invention requires that only the end communicating nodes are securely associated, with no need for cryptographic operations on control traffic at intermediate nodes, two factors that render the scheme efficient and scalable. The processing overhead is placed primarily on the end nodes, an appropriate choice for a highly decentralized environment, and contributes to the robustness and flexibility of the scheme.

The source node S initiates the route discovery, by constructing a route request packet identified by a pair of identifiers: a query sequence number and a random query identifier. The source and destination and the unique (with respect to the pair of end nodes) query identifiers are the input for the calculation of the MAC, along with K (S, T). Route requests are (re-) broadcasted, while the identities (IP addresses) of the traversed intermediate nodes are accumulated in the route request packet.

Nodes maintain a limited amount of information identifying relayed request packets, so that packets that correspond to recent previously seen requests can be discarded. In addition, nodes maintain information regarding the data link and network addresses of their immediate neighbors, and perform a number of simple non-cryptographic checks on the relayed control traffic, based solely on the packet content, and discard non-compliant packets. Intermediate nodes also regulate the service rate they provide to control traffic originating or being forwarded by each neighbor. Finally, they may provide the source of a route with a notification in the event of a path breakage, and may provide route replies, as explained in Section 5.5.

The destination node T validates incoming request packets, and constructs route replies to not previously received queries originating from the source node S. T calculates a MAC covering the route reply contents and returns the packet to S over the reverse of the route accumulated in the corresponding request packet. The destination node T may respond to more than one request packets of the same query, so that it provides the source with an as diverse topology picture as possible.

5.1. The Neighbor Lookup Protocol

The Neighbor Lookup Protocol (NLP) is an integral part of the routing protocol, responsible for the following tasks: (i) It maintains a mapping of MAC and IP layer addresses of the node's neighbors, (ii) it identifies potential discrepancies, such as the use of multiple IP addresses by a single data-link interface, and (iii) measures the rates at which control packets are received from each neighbor, by differentiating the traffic primarily based on MAC addresses. The measured rates of incoming control packets are provided to the routing protocol as well. This way control traffic originating from nodes that selfishly or maliciously attempt to overload the network can be discarded (Section 5.3).

Basically, NLP extracts and retains the 48-bit hardware source address for each received (overheard) frame along with the encapsulated IP address. This requires a simple modification of the device driver, so that the data link address is “passed up” to the routing protocol with each packet. With nodes operating in promiscuous mode, the extraction of such pairs of addresses from all overheard packets leads to a reduction in the use of the neighbor discovery and query/reply mechanisms for MAC address resolution. Each node updates its Neighbor table by retaining both addresses.

The mappings between data-link and network interface addresses are retained in the table as long as transmissions from the corresponding neighboring nodes are overheard. Each entry is associated with a neighbor_lost timeout period and is removed from the table upon expiration. The neighbor_lost timeout period should be greater than the timeout periods associated with the route discovery, such as the maximum delay before a new query is broadcasted.

NLP issues a notification in the event that according to the content of a received packet: (i) a neighbor used an IP address different from the address currently recorded in the neighbor table, (ii) two neighbors used the same IP address (that is, a packet appears to originate from a node that may have “spoofed” an IP address), (iii) a node uses the same medium access control address as the detecting node (in that case, the data link address may be “spoofed”). Upon reception of the notification, the routing protocol discards the packet bearing the address that violated the aforementioned policies.

Even though NLP does not rely on cryptographic validation, it thwarts adversaries from presenting themselves at the routing layer as more than one node. This would have been possible if different IP addresses were inserted in or used as the source address of the control traffic the adversary relays or originates. However, the effectiveness of NLP relies on the fact that MAC are either hardwired or may be changed with substantial latency. In the former case, NLP can provide very strong assurances; in the latter one, it will be a significant line of defense, deterring, for example, a malicious node from flooding the network with spurious traffic. In any case, it should be noted that it is not of interest whether a relay node indeed presented itself with its ‘actual’ IP address, but whether the node participated in the discovery of the route.

5.2 Route Request Generation

The source node S maintains a query sequence number Q_SEQ for each destination it securely communicates with. The 32-bit Q_SEQ increases monotonically, for each request generated by S, and allows T to detect outdated route requests. The sequence number is initialized at the establishment of the SA and although it is not allowed to wrap around, it provides approximately a space of four billion query requests per destination. If the entire space is used, a new security association has to be established.

For each outgoing route request, S generates a 32-bit random Query Identifier Q_ID, which is used by intermediate nodes as a means to identify the request. Q_ID is the output of a secure pseudorandom number generator; its output is statistically indistinguishable from a truly random one and is unpredictable by an adversary with limited computational power. Since intermediate nodes have limited memory of past queries, uniqueness and randomness can be efficiently achieved, by using a one-way function and a small random seed as input. This renders the prediction of the query identifiers practically impossible, and combats the following attack: malicious nodes simply broadcast fabricated requests only to cause subsequent legitimate queries to be dropped.

Along with Q_ID and Q_SEQ, the route request header includes a MAC. The MAC is a 96-bit field, generated by a keyed hash algorithm, which calculates the truncated output of a one-way or hash function. The one-way function input is the entire IP header, the basis protocol route request packet and most importantly, the shared key K (S, T). The route request fields that are updated as the packet propagates towards the destination, i.e., the accumulated addresses of the intermediate nodes, and the IP-header mutable fields are excluded.

The querying source node S may set a number of replies (N_RREP) field of the route request header to indicate the number of route replies per query the destination should return. The source node S may increase N_RREP in case of a failed route discovery or in order to enrich its view of the network topology. Finally, all nodes self-regulate the rate at which they generate new route requests in case of failed route requests, in order to avoid overloading the network.

5.3 Route Request Processing

Nodes receiving a route request parse the packet in order to determine whether an cryptographic header is present. If the request header is not present the packet must be dropped. Intermediate nodes extract the Q_ID value to determine if they have already relayed a packet corresponding to the same request. If not, they compare the last entry in the accumulated route to the IP datagram source address, which belongs to the neighboring node that relayed the request. The request packet is dropped in the case of a mismatch or an NLP notification that the relaying neighbor violated one of the enforced policies. Otherwise, the packet is relayed (re-broadcasted), with the intermediate node inserting its IP address. The Q_ID, source and destination address field values are placed in the query table. Finally, intermediate nodes retain the IP addresses of their neighbors overheard forwarding (re-broadcasting) the query, in a forward_list associated with the query table.

If the route traversed by the request is not accumulated in the packet, the protocol is not susceptible to malicious alterations of the accumulated route. The receiving node records the IP address of the node that broadcasted the request, unless an NLP notification was issued. The predecessor node IP address is appended to the corresponding query table entry that was described above. The functionality related to the forward_list remains as described above.

If the node is the sought destination node T, the route request is validated if T has a security binding with the querying node; otherwise, the packet is discarded. First, Q_SEQ is compared to S_MAX(S), the latest (highest) query sequence number received from S, within the lifetime of the S-T SA. If Q_SE <S_MAX(S), the request is discarded as outdated or replayed. If Q_SEQ=S_MAX(S) and T has already responded to a valid request, i.e., generated a route reply (in general, NRREP replies), the request is disregarded.

Otherwise, T calculates the keyed hash of the request header and verifies its integrity and the authenticity of origin of the request packet. If validated, S_MAX(S) is set equal to max{Q_SEQ,S_MAX(S)} and a route reply is generated, as described in section 5.4.

In order to ensure the responsiveness of the routing protocol, nodes maintain a priority ranking of their neighbors according to the rate of queries observed by NLP. The highest priority is assigned to the nodes generating (or relaying) requests with the lowest rate and vice versa. Quanta are allocated proportionally to the priorities and not serviced low-priority queries are eventually discarded. Within each class, queries are serviced in a round-robin manner.

Selfish or malicious nodes that broadcast requests at a very high rate are throttled back, first by their immediate neighbors and then by nodes farther from the source of potential misbehavior. On the other hand, non-malicious queries, that is, queries originating from benign nodes that regulate in a non-selfish manner the rate of their query generation, will be affected only for a period equal to the time it takes to update the priority (weight) assigned to a misbehaving neighbor. In the mean time, the round robin servicing of requests provides the assurance that benign requests will be relayed even amidst a “storm” of malicious or extraneous requests.

5.4 Route Reply Generation and Forwarding

The destination node T generates one or more replies to each query. The number of replies does not exceed the min{N_RREP,N_NEIGHBORS}. This restriction deters a malicious neighbor from relaying and having more than one route request packets replied, and, thus, possibly controlling more than one route.

The route reply is identified by the values of Q_SEQ and Q_ID of the corresponding route request. The reverse of the route accumulated in the request packet is used as the source route of the reply packet. The destination node T must calculate, using K (S, T), and append a MAC covering the header and the source route of the reply packet. The reply is routed strictly along the reverse of the discovered route. This way, the source node S will be provided with evidence that not only had the request reached the destination, but also that the reply was indeed returned along the reverse of the discovered route.

As the reply propagates along the reverse route, each intermediate relaying node checks whether the source address of the route reply datagram is the same as the address of its downstream node, as reported in the route reply. If not, or if and NLP notification has been received, the reply packet is discarded. The intermediate node should discard the reply if the corresponding request is not previously received and relayed.

Also, the reply packet should be discarded if it originates from a node that is not listed in forward_list. This last control practically eliminates the possibility that a malicious node forms a “dumb” or Byzantine relay, complementing the defense provided by NLP, which would promptly detect the re-use of the node's MAC address. Nevertheless, it is theoretically feasible that the malicious transmission is not overheard, due to a collision at the receiver, that is, the benign that previously relayed the request in question. Such events become now irrelevant to the correctness of the route discovery. A “dumb” relay could have been formed if a node changed its data link and IP addresses as it relayed the request/reply packets to impersonate the previous relay without appearing in the route discovery (i.e., placing its IP address in the route request or relaying the route reply being listed in the source route).

If the reply packet does not contain the entire route, that is, source routing is not used, the intermediate nodes must retain sufficient information to be able to forward subsequent data packets. To do so, they place a temporary entry in their routing table, including the source, the destination, a route identifier, and their predecessor and successor hops. The route identifier is constructed by the destination as the output of a hash or one-way function that operates on the source and destination IP addresses, the current Q_ID and random number chosen by T. The same identifier must be attached by the source at each data packet sent across this route.

Ultimately, the source validates the reply: it first checks whether it corresponds to a pending query. Then, it suffices to validate the MAC, and extract the route from the IP source route of the route reply, which already provides the (reversed) discovered route.

5.5 The SRP Extension

The basic operation of the secure route discovery can be extended in order to allow for nodes, other than the destination, to provide route replies or feedback on the status of utilized routes. This may be possible if a subset of nodes share a common objective, belong to the same group G and mutually trust all the group members. In that case, the mutual trust could be instantiated by all group members sharing a secret key K (G).

Under this assumption, a querying node should append to each query an additional MAC calculated with the group key K (G), which we call Intermediate Node Reply Token (INRT). The functionality of route discovery remains as described above, with the following addition: each group member maintains the latest query identifier seen from each of its peers, and can thus validate both the freshness and origin authenticity of queries generated from other group nodes.

Nodes other than the sought destination respond to a validated request, if they have knowledge of a route to the destination in question. The route reply is generated as above, except for the MAC calculation that uses K (G). The correctness of such a route is conditional upon the correctness of the information provided by the intermediate node, regarding the second portion of the route. When the route reply is generated by the destination, an additional MAC(K(G),route_reply) should be appended apart from the MAC(K(S,T),route_reply). This would allow an intermediate node V that is part of the route and a member of G to utilize the discovered route suffix (i.e., the V to T part).

The INRT functionality can be provided independently from and in parallel with the one relying solely on the end-to-end security associations. For example, it could be useful for frequent intra-group communication; any two members can benefit from the assistance of their trusted peers, which may already have useful routes. Finally, the shared K (G) can be utilized for purposes that are beyond the discovery of routes. The authentication of route error messages, as explained in section 5.6, is one such example.

5.6 Route Maintenance

A “route error” packet should be generated by an intermediate node that fails to deliver a data packet to the next hop. In comparison to route error messages used by other MANET protocols, it is required that the node reporting the path breakage provides the path and message identifiers carried by the data packet, both used by the secure data forwarding protocol. In all cases, route error packets must be source-routed to the source node S along the prefix of the route being reported as broken. The intermediate upstream nodes, with respect to the point of breakage, must check if the source address of the route error datagram is the same as the one of their downstream node, as reported in the broken route.

If there is no NLP notification that the relaying neighbor violated one of the enforced policies, the packet is relayed towards the source. In this case, NLP prevents an adversary that does not belong to but lies at a one-hop distance from the route from generating an error message. In such case, an inconsistency with the addresses already used (during the route discovery) by the actual downstream neighbor will be detected. The end node must compare the source-route of the error message to the prefix of the corresponding active route. This way, it verifies that the provided route error message refers to the actual route, and that it is not generated by a node that is not part of the route.

The correctness of the feedback (i.e., whether it reports an actual failure to forward a packet) cannot be verified though. As a result, a malicious node lying on a route can mislead the source by corrupting error messages generated by another node, or by masking a dropped packet as a link failure. However, this allows it to harm only the route it belongs to, something that was possible in the first place, if it simply dropped or corrupted in-transit data packets.

Route error messages do not include a MAC since intermediate nodes do not have a security association with the end nodes. This allows an adversary that can spoof a data link address and lies within hop of an end-to-end data flow (route) to inject a route error. This would be possible if it impersonated a node that is part of the route. Although the NLP of the victim would issue a notification, the forged route error would be in-transit towards the source.

Route error messages are used in the following cases: (i) the intermediate issuing node has a secure association with the source node, (ii) an end-to-end secure mechanism is present and thus the source node can infer the status of the utilized route(s). In case (i), an intermediate node that is member of the same group uses the group key to generate a route error MAC that covers the entire packet and its IP source route. In case (ii), the route error packets are used only in a complementary manner.

Unauthenticated route error messages are used tentatively to update the ‘rating’ of the utilized route(s). The source retains at most one route error per reported broken route and updates the path rating only when the end-to-end feedback becomes available. In particular, if the secure data forwarding feedback indicates that a route failed, that is, the transmitted data is not acknowledged, then the route error is used to further decrease the rating of the route. Inversely, if the end-to-end feedback provided by the trusted node shows that transmissions were successful, unauthenticated route errors are ignored and discarded.

6. Secure Data Forwarding

The basic idea behind the secure data forwarding protocol, otherwise known as the secure message transmission (SMT) protocol, is to combine efficient end-to-end security services and a robust feedback mechanism, with dispersion of transmitted data and simultaneous usage of multiple paths. At the same time, continuous reconfiguration driven by an easy-to implement method allows the adaptation of the secure data forwarding to the requirements of the networking environment. For each outgoing message limited redundancy is introduced and the data with the redundant information are divided to a number of pieces.

The information dispersal is based on the algorithm proposed by M. O. Rabin in “Efficient Dispersal of Information for Security, Load Balancing, and Fault Tolerance,” Journal of ACM, Vol. 36, No. 2, pp. 335-348, April, 1989. Rabin's algorithm is in essence an error correction code, in the sense that it adds redundancy to the data to allow recovery from a number of faults. Assume that one desires to be able to reconstruct the original message with successful reception of any M out of N transmitted pieces. Initially, N random M-vectors, organized as rows of matrix A, are selected, so that any M of them are linearly independent. The message of size F bytes is segmented into pieces of length M, being the columns of matrix B, with L=F/M. The dispersed (encoded) message pieces are the rows of matrix W. (Note that bytes/characters are treated as integers.) Since the corresponding M rows of A are, by definition, linearly independent, the matrix A′ comprised of these vectors, is also invertible. The vectors of matrix A can be selected from a pre-computed set used by both ends, which is assumed to be agreed upon at the SA establishment.

Due to the message dispersion, the reception of a sufficient number of pieces allows successful reconstruction at the receiver's side. A cryptographic header is appended to each piece and the dispersed message is transmitted over a set of diverse, preferably node-disjoint paths. Diversity is welcome, so that a malicious node cannot harm more than one piece.

The receiver validates the incoming packets and acknowledges the successfully received packets, with the feedback crypto graphically protected as well. If a sufficient number of pieces were received, the receiver reconstructs the message. Otherwise, it awaits the additional needed packets to be retransmitted by the sender. Once the message is successfully reconstructed, it is passed to the upper protocol layers.

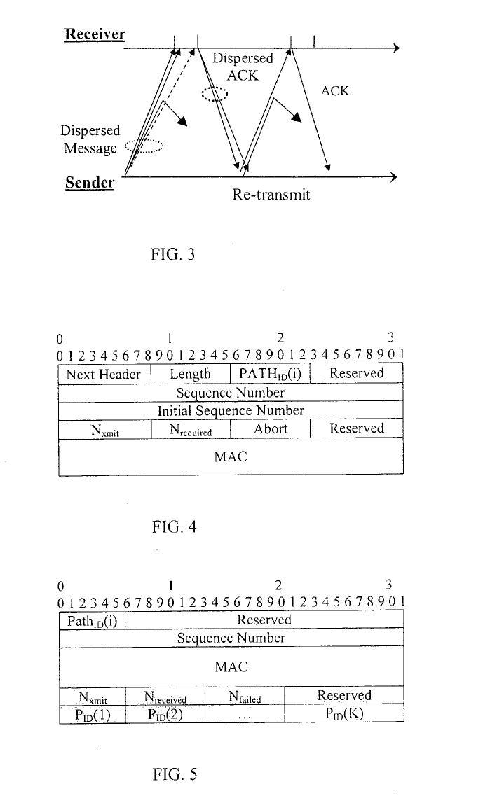

An illustrative example of a single message transmission is shown in FIG. 3. The sender disperses the message, so that any three out of four packets are sufficient for successful reconstruction. The four packets are routed over four disjoint paths and two of them arrive intact at the receiver. The remaining two packets are compromised by malicious nodes lying on the corresponding paths; for example, one packet is dropped, and one (dashed arrow) is modified. The receiver extracts the information from the first incoming validated packet and waits for subsequent packets, while setting a reception timer. When the fourth packet arrives, the cryptographic integrity check reveals the data tampering and the packet is rejected.

At the expiration of the timer, the receiver generates an acknowledgment reporting the two successfully received packets and transmits it across the two operational paths. It is sufficient for the sender to receive and cryptographically validate only one acknowledgment, ignoring duplicates. The two missing pieces are then retransmitted; however, one of the two packets is lost, for example, because of intermittent malicious behavior, or a benign path breakage. The receiver acknowledges the successful reception immediately, before the timer expiration, since an adequate number of packets have been received. In all cases, the sender sets a retransmission timer, so that total loss of all the message pieces or of all the acknowledgments is detected.

6.1. Protocol Definition

The two communicating end nodes make use of the Active Path Set (APS), comprising diverse paths that are not deemed failed. The sender invokes the underlying route discovery protocol, updates its network topology view, and then determines the APS for a specific destination. This model can be extended to multiple destinations, with one APS per destination. At the receiver's side, the APS is used for the feedback transmission, but if links are not bi-directional, the destination will have to determine its own “reverse” APS. The dispersion of messages is coupled to the APS characteristics, and the appropriate selection of the dispersion algorithm parameters is discussed in detail below.

Once dispersed, the message pieces are transmitted across APS in crypto graphically protected packets. If the message cannot be reconstructed at the destination, the source retransmits the pieces that were not received, according to the feedback that is verifiably provided by the destination. Message pieces are re-transmitted by SMT a maximum number of times, RetryMAX, which is a protocol-selectable parameter. If all re-transmissions fail, the message is discarded. This way, a number of retransmissions by SMT enhance its efficiency, by alleviating the overhead from re-transmitting the entire amount of data. On the other hand, SMT does not assume the role of a transport or application layer protocol; its goal is to promptly detect and tolerate compromised transmissions, while adapting its operation to provide secure data forwarding with low-delays.

The transmission of data is continuous over the APS, with re-transmissions placed at the head of the queue upon reception of the feedback. The continuous usage of the APS allows SMT to update fast its assessment on the quality of the paths. Moreover, the simultaneous routing over a number of paths, if not the entire APS, provides the opportunity for low-cost probing of the paths. The source can easily tolerate the loss of a piece that was transmitted over a low-rated path, and the benefit from doing so can be two-fold: either the piece will be lost but the rating of a failing path will be further decreased and removed from the APS, or, the piece will be successfully received and contribute to the re-construction of the message, if an adversary lying on the path misbehaves intermittently.

The adaptation of the protocol takes into consideration the network state and the requirements of the supported application. In particular, it is the result of the interplay among the following parameters: (i) K, the (sought) cardinality of APS, (ii) k, the S,T-connectivity, i.e., the maximum number of S-T node-disjoint paths from the source (S) to the destination (T), (iii) r, the redundancy factor of the information dispersal, and (iv) x, the maximum number of malicious nodes. The misbehavior pattern of the adversaries is an additional factor that affects the operation of the protocol; if, ideally, this could be predicted, the protocol could optimally be reconfigured. However, this could be extremely difficult if an adversary selects which transmissions to corrupt in a pseudo-random manner. If it is assumed that no more than X % of the nodes may act maliciously at any time instance, then x=X*a, with the number of network nodes denoted by a. In particular, nodes may either estimate or be given an estimate or prediction of the percentage of malicious nodes, which can be viewed as the probability that any single node is malicious. Instead of a, a node can use the number of nodes in its topology view.

Path diversity is the primary goal to meet in order to provide increased protection by disallowing any single malicious node to compromise more than one data flow. In general, the sender needs to determine a sufficiently high number of paths in order for the dispersed message to be successfully received. Although this is the most obvious solution, one cannot expect that in every occasion a high number of paths will be found. In low connectivity conditions (small number of disjoint paths), the sender can increase the redundancy factor in order to provide increased assurance and possibly low transmission delay. If M out of N transmitted packets are required for successful transmission, r=N/M, and, for an allocation of one piece per path, K should be at least M. The larger K is, the higher the number of faults that can be tolerated. Equivalently, the higher x is, the larger K should be for a fixed r. For an APS of K paths, the required number of packets is K/r. The condition for successful reception is x≦|K×(1−r⁻¹)| which shows the relationship among the parameter values.

The data transmission protocol operates as follows: For a given K, the sender constructs an APS of k≦K node-disjoint paths, depending on the actual node connectivity of its topology view. This can be done by constructing k node-disjoint paths connecting the two end nodes, using with the number of hops as cost, so that the shortest k-path set has the minimum sum of the path lengths. Alternatively, a minimum-cost maximum-flow algorithm with unit node capacities and a fixed goal of k paths can yield the same result. It is noted that other cost measures could be used as well.

If k<<K, then the sender can enhance the resilience of the communication by determining additional, partially disjoint paths. Given a set of k node-disjoint paths, additional K−k paths can be calculated, partially overlapping with the node-disjoint ones. If less than k malicious nodes lie on the selected paths, at least one or more packets will reach the destination. For any additional non-disjoint path, the number of faulty paths that can be tolerated increases in practice, but no guarantee can be provided for the worst case, without knowing the actual overlapping information. If the adversarial nodes constitute a cut of cardinality C_{X}, the result would be either a partitioned network (C_{X}≧k) as seen by S and T, or a mere failure to reconstruct the message at the receiver (C_{X}≧k−M).

With the K-path at hand, the source determines the values required to achieve a secure transmission. In particular, K can be determined as a function of r, so that the probability of successful transmission is maximized. In order to do so, the source starts by determining an APS of k paths, as described above. Then, let P_{GOAL} be the target probability of successful reconstruction of a dispersed message. P_{GOAL} can be provided from the application layer and correspond to the features of the supported application for example. Given P_{GOAL}, and k, the node calculates the corresponding redundancy factor, r_{GOAL}, and disperses outgoing messages with the redundancy value closest to r_{GOAL}. Note that the source may achieve similar results with different values of M and N, a flexibility that is proven valuable.

If N<k, the node selects the N paths of the APS with the highest rating. Similarly, the few first most highly rated paths are selected for re-transmissions, that is, transmission of fewer than M pieces. As this process continues, paths will be deemed failed, thus reducing k. Then, the node repeats the abovementioned algorithm. While transmitting across the APS, the source updates the rating of the paths. For each successful or failed piece, the rating of the corresponding path is increased or decreased, respectively. When the rating drops below a threshold, the path is discarded, which implies that its constituent links are discarded as well. The path rating is also decreased slowly as time goes by, in order to reduce the chance of using a stale path.

This last procedure implies that the determination of the APS is performed in parallel and it can contribute to the update of the topology view of the node. The reverse interaction is also possible, if for example route error messages are taken into consideration to update the path rating. Furthermore, an alternative implementation could reduce a metric for each of the path's constituent links, when it is removed from APS, and discard links only when their metric drops below a threshold.

6.2. Additional Design Considerations

6.2.1. Message Transmission

Upon transmission, the sender sets a retransmission timer (RTO) in order to detect the loss of all message pieces. If RTO expires, it is safely assumed that either none of the transmitted packets was received, or all acknowledgements were lost. The 28-byte SMT protocol header as illustrated in FIG. 4 is attached to each IP packet carrying a message piece to secure its transmission. The monotonically increasing Sequence Number is randomly chosen at the establishment of the security association, providing an ample space of approximately four billion numbers. The sequence is not allowed to wrap around its initial value; in that case, a new SA is established.

The same sequence number is assigned to all pieces of a single transmission across APS, with each piece uniquely identified by PATHID(i), the distinct identifier of the i-th path of the APS. Moreover, the numbers of transmitted and required pieces, Nxmit and Nrequired respectively, are independently chosen by the source and they may vary over time. The Message Authentication Code (MAC) is the 96-bit output of a keyed hash algorithm, which is practically the truncated output of a one-way or hash function. The one-way function input covers the shared key KS,T and the entire datagram, excluding only the mutable fields of the IP header.

The Initial Sequence Number identifies the first, failed transmission, and relates it to the possible subsequent retransmissions, so that pieces can be combined. However, it is possible that previously received pieces become useless for the message reconstruction. Then, in conjunction with the Abort flag, the receiver is notified to flush such pieces. For example, the source may re-encode the message, if only a very small fraction of packets were received, and the redundancy factor or the APS changed significantly.

The receiver determines the freshness of each piece thanks to the replay protection mechanism and, if the origin authenticity and integrity are also verified, the piece is buffered. Upon receipt of the first valid piece of a message, the reception timer (RCT) is set and the message is designated as pending. The receiver provides feedback when N_{required} pieces are received, or, if this does not happen, when RCT expires.

Although usually protocols fix default values for timeouts, SMT avoids detrimental delays when significant packet loss forces RCT to expire thanks to a simple scheme for adapting RCT. Under the assumption that both end nodes know some worst-case value RCT_{MAX}, RCT is related to RTO at the sender's side: If RTTₘᵢₙ is the minimum, among all packets within a connection, round-trip time (excluding delays incurred by the receiver), and if similar delays are incurred by non-corrupted paths on both directions, then it must hold that RTTₘᵢₙ+RCT<RTO, because the reception of a single valid acknowledgement suffices.

In order to satisfy this inequality, the source calculates an estimate RTTₑ of the round-trip time based on its interaction with the network during the route discovery phase, and selects RTO=RTTₑ+RCT_{MAX}. The calculation of the RTTₑ utilizes both route reply packets and SMT acknowledgements. Both types of traffic, which is exchanged in an end-to-end manner provide for an up-to-date estimate of the network load and the imposed delays. At the other, the receiver increments RCT progressively, over a set of predefined values RCTᵢ. Initially, it sets the timer to RCT₁, a fraction of RCT_{MAX}. If at least aᵢ percent of the N_{required} packets arrive, with aᵢ corresponding to RCTᵢ, RCT=RCT₂+RCT₁, with RCT₂<RCT₁. Then, the new threshold is a₂>a₁, and if not enough packets arrive, RCT expires. As the threshold increases, the RCT increments become smaller, since the marginal utility from extending the RCT also becomes smaller. As a result, significant packet loss does not incur high delays.

6.2.2. Feedback

The SMT feedback provides explicit information on the transmitted pieces, regardless of the successful reconstruction of the message. The numbers of received and failed paths are denoted by N_{received} and N_{failed}, respectively, out of a total of Nₓₘᵢₜ transmitted pieces. Moreover, the P_{ID}(i) identifiers of the paths that correspond to the successful transmissions are placed in the acknowledgment, as shown in FIG. 5. These identifiers are the PATH_{ID}(I) assigned by the source.

The sequence number allows verifying the freshness of the feedback, if its authenticity and integrity are validated. The MAC covers only the header and payload but not the source-route option, if included, since it is the information in the payload and not the reception of the acknowledgement that indicates which packets were successfully received.

The remaining paths, whose identifiers are not included in the acknowledgment, are implicitly considered failed. This way the size of the feedback is kept small and the receiver can maximally disperse, i.e., replicate, and transmit the feedback pieces across the successful paths. The fact that a single valid replica of the feedback suffices compensates for the event of intentional or unintentional loss that would force the RTO at the sender's side to expire. As a result, the responsiveness of the protocol is enhanced. Alternatively, the receiver could respond to each received piece with a dispersed acknowledgement. This way, increased assurance and simplicity is provided at the expense of transmission overhead, implying that this would be plausible in cases of low load (e.g., sporadic communication).

Finally, upon reception of a valid acknowledgement that reports Nreceived≧Nrequired, no further action is taken by the sender, except for freeing its buffer from the dispersed message. Otherwise, the remaining pieces are re-transmitted, with the total number of re-transmissions per message not exceeding RetryMAX.

6.2.3. Replay Protection

The proposed reply-protection mechanisms are similar to the ones that are incorporated in the IPsec protocols and rely on a sliding window. However, there are some differences to address the particular aspects of the problem: (i) a sliding window is used by both the sender and the receiver for each direction, (ii) the mechanism at the receiver's side keeps track of each individual piece of a message, due to the use of multiple paths, and (iii) both windows “advance” according to time-outs.

The window at the sender's side represents the sequence numbers of pending acknowledgements, that is, ones not yet received and validated within the corresponding RTO. Although the RTO expiration regulates the growth of the window, finer control of outgoing transmissions is provided by enforcing a maximum number of pending acknowledgements.

At the receiver the window determines the pending messages. Additionally, a list of received pieces containing the corresponding path identifiers is maintained per message. Possible gaps in the window, due to loss of consecutive messages, are dealt with by enforcing a maximum window size. Finally, if the receiver is aware of the transmitter's window size, it can readily discard, without cryptographic validation, packets that are well beyond the expected range of sequence numbers.

6.2.4. Discussion

SMT can operate with any underlying routing protocol, although the use of a secure protocol is beneficial. Moreover, SMT is independent of the form of the provided routing information—for example, it can operate in conjunction with a distance vector protocol. However, the knowledge of the actual connectivity and the use of source routing result in two advantages. On one hand, it is possible for the sender to implement an arbitrary path selection algorithm in order to increase its assurance. For example, it could even incorporate subjective criteria, such as nodes to be explicitly included or excluded from the APS. On the other hand, no discretion on route decisions is given to intermediate nodes, and the vulnerability is reduced, since the SMT operation cannot be compromised by within-the-protocol attacks.

In terms of the characteristics of the network SMT is envisioned to operate, it was shown that a large and very dense network is not a prerequisite. SMT can operate effectively under low-connectivity conditions, but it can benefit from topological redundancies that are inherent in multihop networks. The low computational and transmission overhead renders the protocol efficient and scalable. However, SMT might not be easily and directly applicable in efficiently exchanging data within any application, with one example being a sensor field. SMT appears as the appropriate choice for general purpose MANET, where a node needs to communicate securely with only a small fraction of destinations compared to the total number of nodes in the network.

7. Protocol Analysis

One or more routes are discovered, and their correctness is verified from the route “geometry” itself. Route requests propagate verifiably to the sought trusted destination. Route replies are returned strictly over the reversed route, as accumulated in the route request packet. Moreover, intermediate nodes do not relay route replies unless their downstream node had previously relayed the corresponding query. In order to guarantee this crucially important functionality, the interaction of the protocol with the IP-related functionality is explicitly defined. An intact reply implies that (i) the received reply (which can include the entire discovered path) was provided by the destination, and (ii) the corresponding connectivity information is correct, since the reply was relayed along the reverse of the discovered route and consists of all nodes that participated in both phases of the route discovery.

The securing of the route discovery deprives the adversarial nodes of an “effective” means to systematically disrupt the communications of their peers. Despite our minimal trust assumptions, attackers cannot impersonate the destination and redirect data traffic, cannot respond with stale or corrupted routing information, are prevented from broadcasting forged control packets to obstruct the later propagation of legitimate queries, and are unable to influence the topological knowledge of benign nodes.

To that extent, very strong assurances on the correctness of the link-level connectivity information are provided as well. Adversarial nodes are precluded from forming “dumb” relays and controlling multiple potential routes per source-destination pair. Nevertheless, with the adversary within the transmission range of the destination the last two defenses are somewhat weakened. Additionally, two colluding adversaries might be able to “tunnel” the query and the corresponding reply packets to each other within a single query/response phase. Then, the validated route would provide partially correct link information only. However, this vulnerability is not specific to our protocol: such information could not be distinguished from the actual link connectivity, even under the assumption of a fully trusted network.

The secure data forwarding protocol protects the integrity and provides for the authenticity of the origin of the transmitted data and the corresponding feedback. Moreover, it disallows replays of data and feedback packets. Furthermore, it is not possible for adversaries to misroute data packets and convince the communicating nodes that the utilized route is intact.

8. Performance Evaluation

Numerous experiments have been conducted to evaluate the performance of the secure communication scheme of the present invention. These experiments demonstrated that the cost of the introduced security measures remains low, while the protocol retains its responsiveness and its ability to deliver data, to the extent of being competitive to leading reactive MANET protocols that do not take security into consideration (and thus do not suffer from the resultant overhead and limitations). Furthermore, the protocol is resilient to a number of attacks even though the number of adversaries may be significantly high. This is true for attacks that disrupt both the route discovery and the data forwarding.

Two attack models were employed in experiments on the route discovery protocol. For Attack 1, each malicious node corrupts the header of route requests it receives and relays them towards the destination. For Attack 2, each adversary corrupts the prefix of the accumulated route in the request packets it receives and relays them towards the destination. In addition, it maintains the knowledge of routes to each of the sources it attacks, in order to forward the reply. Under Attack 1, the destination node is capable of promptly detecting and discarding the corrupted request packets. Under Attack 2, the destination has no choice but to extract the tampered connectivity information and return a reply; this reply will be (mis-) routed by the adversary back to source, which will be able to identify the corruption and reject the route. Also evaluated were the same two attacks when they are mounted persistently and when adversaries decide with some fixed probability to corrupt a control packet (intermittent attacks).

The attack model against the data forwarding protocol presumed that in-transit data packets are corrupted by malicious adversaries and relayed to the destination. The destination of course discards such corrupted data and acknowledges the receipt of intact pieces. Attackers corrupted data packets with varying persistency for different settings, ranging from the corruption of all packets to a small fraction of such packets.

None of the above-described attacks can be “fully successful” against the secure routing protocol of the present invention. In other words, the source will not accept and make use of incorrect connectivity information, and will not accept and utilize forged or replayed feedback originating from nodes other than the destination. Analogously, the destination will not accept outdated or forged data and utilize them to reconstruct a message. However, these attacks were selected as they appear to be more “effective” than other ones, in that they succeed in affecting the capability of the protocol to promptly deliver data.

Experiments with other forms of attacks were also conducted: the simple dropping of the routing packets; the injection of fabricated requests and replies; the random generation of forged route requests that attempt to “predict” the random identifiers of legitimate queries and force intermediate nodes to drop them, thus obstructing the route discovery; the corruption or misrouting of route replies; the (non-) detectable corruption of the route request only without relaying the reply back to the source; the corruption of the destination feedback only. Comparatively, the selected types of attacks succeed in further consuming network and node resources: they narrow the potential view of the topology that the querying node can acquire, force the protocol to increase the transmission and control redundancy, and cause longer delays.

A high fraction of delivered packets and low end-to-end delays show that the protocol is successful in dealing with different mobility and load situations. As mobility decreases, both performance metrics improve, while an increase of the load causes a slight degradation in performance. In all cases, the secured protocol practically matched the performance of DSR, which has additional sources of topological information (aggressive caching, intermediate nodes providing routes) and assistance for transmitted data (packet salvaging by in-route nodes).

On the other hand, the control overhead imposed by the discovery of routes is significantly higher for the subject protocol, although it rapidly decreases as mobility decreases as well. The increase in control overhead is the result of route request packets propagating throughout the network unless they are responded by the sought destination. Instead, in DSR, within a few simulated seconds, the majority of route replies is provided by intermediate nodes, which cache connectivity information they extract from in-transit and overheard replies, requests, and data packets. Such sources of topological information are unavailable to the protocol of the subject invention, since there would be guarantee on its correctness. As a result, the only possibility (for the basic form of secure discovery) is to rely solely on the destination for the route discovery, while intermediate nodes that detect a path failure are unable to locally repair it.

A breakdown of the control traffic shows that in its largest part it comprises route requests. This could be viewed as a reason for keeping the processing overhead low. Since the source can regulate the number of replies provided by the destination, an increase of the replies increases significantly the portion of reply packets over the total overhead. This increase is the result of the significant decrease of number of route queries and request packets: additional, redundant routes can sustain communication for longer periods.

The overhead from cryptographic mechanisms, which is a factor specific only to protocols bearing security features, was also examined. For each node, the overall rate at which the protocol has to calculate MAC's for control packets was measured. It should be noted that the measurement averages only over the nodes that actually perform cryptographic operations, i.e., only the end communicating nodes. The resultant overhead was surprisingly low despite the high routing load. On the one hand, this processing overhead depends on the number of hashed control bits rather than the number of control packets. In case of route requests, the portion covered by the MAC is constant, while route replies vary according to the route length, increased by the length of an IP address (in bits) per additional hop.

With the above observation on the composition of control traffic at hand, one can interpret the cryptographic overhead curves. For high mobility, the source frequently retransmits new queries, thus, the cost of query calculation and validation are dominant, while for lower mobility lower overhead is imposed. If the number of replies increases, the relative decrease of requests counterbalances the overhead. In all cases though, the cryptographic cost on route discovery appears to be trivial, compared to cost imposed from the protection of the data.

In order to make the impact of attacks more visible and easily distinguishable from that of benign failures, the operation of the protocol under attack was examined in a lightly loaded network. The experiments demonstrated that the routing protocol delivers a high percentage of data packets even in the presence of adversaries that actively disrupt the route discovery. For example, more than 93% of the data packets were delivered when 20% of the network nodes were attackers. Moreover, the percentage of delivered packets decreases slowly as the number of adversaries increases, even though 60% of the nodes misbehave. Finally, a very similar impact was noted for both types of attacks and for different mobility, in terms of the packet delivery ratio.

The degradation in performance is the result of the propagation of corrupted queries and the subsequent suppression of “duplicates,” i.e., the discarding of query packets that correspond to the same request (reminder: the route discovery relies on the control of the request floods; each node rebroadcasts a request only once per query). Consequently, an area of the network will be covered by such corrupted requests, and will deprive the end nodes from correct, and possibly “better,” routes.

The similarity for the different mobility scenarios can be explained, since the impact of the attack depends on the relative placement of the nodes. A number of adversaries may effectively reduce the connectivity of a near-by node, or even deprive it from communication until the topology and thus the S-T connectivity changes.

For high mobility, the initial random placement of nodes does not weigh significantly; in a frequently changing network, benign nodes will be within range of adversaries transiently, but at the same time pairs of nodes that communicate successfully will frequently experience benign path breakages, or become associated with adversaries. For low mobility, however, both “good” and “bad” connectivity will be experience for longer periods. As a result, a portion of communicating pairs will undergo significant failures (e.g., send buffer overflow because of obstacles in route discovery), while another portion will not. In essence, for high mobility, the topological changes even out the impact of attacks, while, for low mobility, the impact of attacks is averaged out because of the disparate harm inflicted on different nodes.

The impact of the presence of attackers becomes visible when one considers the end-to-end delay. The delay due to failed route discoveries or the discovery of longer or short-lived routes, because of the above-explained blocking of legitimate query packets, is the dominant factor for the observed delay. As the number of adversaries increases, the increase of such delays cannot be avoided. Moreover, the delay makes the distinction between the two types of attacks clearer. For Attack 2, a significant portion of the replies are given to corrupted requests and, thus, result in discarded route replies, while, for Attack 1, all such requests are readily discarded by the destination. Depending on the placement of the adversaries and the number of replies requested by the source, Attack 2 can result in repeated failures.

However, by increasing the number of replies (which can be determined individually by each node that either experiences long route discovery delays or lacks sufficiently many routes), the impact of Attack 2 can be moderated. In fact, as the number of adversaries goes up, the number of replies requested increases. This allows our protocol to maintain the same performance under more adverse conditions. At the same time, under Attack 2 the control overhead was found to be relatively higher than under Attack 1. Nevertheless, it is important that despite the increase of the number of adversaries, the control overhead remains relatively constant or increases slowly over the range of the number of attackers.

The performance evaluation of SMT shows that the protocol is both efficient and highly effective in the presence of a large number of adversaries. First, the operation of SMT was evaluated in a benign environment to identify the impact of its features to secure the forwarding of data. This showed that SMT can indeed adapt its operation and achieve low overhead. Second, SMT was evaluated in an adverse environment, with attackers actively disrupting the transmission of data. SMT is effective even when half of the network nodes are adversaries and delivers 120% more data packets than a protocol that does not secure data forwarding.

A detailed simulation model of the subject presented protocol was developed and the adversarial behavior and in all experiments, the basic form of secure route discovery was implemented. No additional trust assumptions were made beyond the end-to-end security associations, which implies that intermediate nodes are not allowed to respond to route requests. More specifically, each source is securely associated with one destination and vice versa, with each node communicating (transmitting and receiving) with at most two other nodes; sources transmit data to the same destination throughout the simulated period.

The experiments showed that SMT can successfully deliver data under different mobility scenarios. The addition of features to secure the transmission of data does not undermine the responsiveness of the protocol. SMT detects the breakage of a path when acknowledgments for the transmitted pieces are not received. Moreover, SMT enhances the security of the route maintenance by relying primarily on end-to-end feedback. It utilizes route error packets provided by SRP only when the route error packet reports the breakage of a route that is also deemed failed due to the feedback from the trusted destination. This way the protocol is fully secured against misreported route errors that could otherwise result in discarding a possibly intact route.

SMT was also observed to operate mostly using a low number or even a single path, when node transmissions are not deemed failed. This results in low routing overhead, since it is not required to maintain an APS of high cardinality. However, the improvement in end-to-end delay and the low increase of routing overhead are due to the use of more than one path, for a fraction of the message transmissions. In fact, SMT achieves 45% lower delay than SRP alone, which shows that SMT is capable of supporting real-time traffic.

The use of Message Authentication Codes (MAC's) renders the protocol highly efficient, since the imposed processing overhead remains low. This is due to the end-to-end operation of SMT, which allows the use of symmetric key cryptographic tools. Nevertheless, the computational load due to the cryptographic operations is an important factor that determines the practicality of the protocol. The number of MAC calculations is not the limiting factor. What is more important is the number of bytes the MAC operates on. Approximately half of the exchanged packets are of small size (feedback) and their MAC calculation is of low cost. The increase of the processing load is the result of the MAC attached to each message piece and each SMT acknowledgement. In contrast, SRP alone did not provide protection for data transmissions, and the processing load was due to the protection of control traffic alone.

The effectiveness of SMT in an environment with attackers that corrupt the in-transit packets was also verified. As the number of adversaries increases, the ratio of delivered packets decreases slowly. In contrast, without SMT, SRP is severely affected by the attacks and delivers significantly fewer packets. The improvement due to SMT becomes higher as the number of adversaries increases.

It was noted that SRP, or any other routing protocol, cannot avoid a “compromised” route. Once a malicious node has placed itself on the utilized route, it can drop packets until one of its upstream links along the utilized route break. As a result, even a small percentage of adversarial nodes are sufficient for inflicting substantial harm to the network operation. Consequently, the protection of the data transmissions is of paramount importance, and it has to address both the security and the fault-tolerance of the transmission. SMT does exactly this, by securing the transmission of data from arbitrary malicious behavior.

To cope with attackers, SMT increases the transmission redundancy. Initially, SMT utilizes all or a large fraction of the available paths initially, trying to maximize the chances of successful transmission. As one more of them are deemed failed, SMT continues transmitting across the operational paths. This way, unnecessary redundancy is avoided, and at the same time the network load is kept low. An additional reason for the low transmission overhead is the selection strategy for the required number of paths: the minimum number of paths that yield the Pgoal=0.9 is selected, with the minimum possible number of pieces required for successful reconstruction of the message at the receiver.

However, the higher the number of adversaries, the more probable a discovered path will contain an attacker. SMT can promptly adapt and avoid a non-operational path, or resort to a partial retransmission of missing pieces. Nevertheless, it is not infrequent that the protocol has to operate under low connectivity conditions. When 40% or 50% of the nodes act as attackers, the probability of success is in most cases very low. As a result, a new route discovery is the only way for nodes to maintain communication when all paths made available by SRP are deemed failed.

### 9. CONCLUSION

The routing protocol of the present invention secures both the route discovery and the data forwarding operation for MANET routing protocols. The protocol is capable of operating in a purely end-to-end manner; it guarantees the acquisition of correct connectivity information even in the presence of a very high percentage of individual attackers; it utilizes feedback originating only from one of the two communicating end-nodes to determine both the availability and security of the utilized paths; it introduces transmission redundancy to mask malicious failures; and, it relies on low-cost encoding and cryptographic validation mechanisms.

The performance evaluation of the protocol shows that it remains efficient and effective even when a high percentage of the networks act as active attackers. A wide range of attacks is successfully countered and data are delivered to their destinations. Moreover, by relying solely on an end-to-end security association, the protocol can achieve practically 100% secure transmission without prior knowledge of the network security level or the trustworthiness of the intermediate nodes. In addition, such highly secure transmissions can be achieved with low overhead, both in terms of the transmitted data and the number of utilized paths. Self-configuration allows the protocol to remain effective even in the absence of a rich topology.

Although the invention has been disclosed in terms of a number of preferred embodiments and variations thereof, it should be understood that numerous modifications and variations could be made thereto without departing from the scope of the invention as set forth in the appended claims. For example, the protocol can also be straightforwardly applied in the special case that an authorization mechanism is present. In particular, nodes establish or make use of a secure association with their immediate neighbors (nodes within their radio transceiver's range) bearing the necessary credentials. This suffices to achieve the protocol's goals without requiring that at every instance a node maintain a secure association with all network nodes. As a result, the protocol achieves equally strong or improved security over that provided by other schemes that make significantly stronger assumptions on the network trust and membership and the node equipment. More importantly, this allows the protocol to scale for networks of large size and changing membership. Another example is the alternative operation of the protocol without the use of source routing, as described previously. This renders the subject protocol more generally applicable, beyond a class of MANET routing protocols that utilize source routing. It should also be noted that the secure message transmission protocol achieves its goals under less restrictive assumptions: it can operate in the absence of bi-directional links, and colluding adversaries do not affect it.

What is claimed is:

1. A method for secure discovery of a communication transmission route between nodes in a multiple node ad hoc network, said network including a source node, a destination node and one or more intermediate nodes, said method comprising the steps of:
providing a secret encryption key only to said source and said destination nodes in said network;
generating a route discovery request at said source node, said request including a source node identifier, a destination node identifier, a sequence number identifier for said request and a first message authentication code that is generated by applying a predetermined mathematical formula using said source node identifier, destination node identifier, sequence number identifier and said secret key as arguments;
broadcasting said route discovery request from said source node to any of said intermediate nodes in said ad hoc network that are in range to receive said broadcast;
for each of said intermediate nodes that receives said request, relaying said request to additional ones of said nodes in said network;
upon said request being received by said destination node, verifying the authenticity of said route request using said secret key and said message authentication code;
if the authenticity of said route request is verified by said destination node, generating a reply to said route discovery request, said reply including a source node identifier, a destination node identifier, a sequence number identifier for said reply and a second message authentication code that is generated by said destination node by applying said predetermined mathematical formula using said source node identifier, destination node identifier, sequence number identifier and said secret key as arguments;
transmitting said reply from said destination node to said source node using the same route used for transmitting said route discovery request from said source node to said destination node; and
upon receipt of said reply by said source node, verifying the authenticity of said reply using said secret key and said second message authentication code, said authenticity also inherently verifying both that the reply was generated by said destination node and was transmitted over a discovered route from said source node to said destination node, whereby, said source node can use said reply information to send messages to said destination node over said discovered route.
